(19) United States
(12) Patent Application Publication
(10) Pub. No.: US 2013/0293204 A1
(43) Pub. Date: Nov. 7, 2013

(54) CONTROL CIRCUIT FOR REDUCING SWITCHING LOSS OF BUCK-BOOST CONVERTER AND RELATED SWITCHING REGULATOR

(71) Applicant: RICHTEK TECHNOLOGY CORPORATION, Hsinchu County (TW)

(72) Inventor: Chien-Ping LU, Tainan City (TW)

(73) Assignee: Richtek Technology Corporation, Hsinchu County (TW)

(21) Appl. No.: 13/863,889

(22) Filed: Apr. 16, 2013

(30) Foreign Application Priority Data
May 7, 2012 (TW) 101116279

(51) Int. Cl. H02M 1/00

(52) U.S. Cl. CPC H02M 1/00
USPC 323/234

(57) ABSTRACT

The switching regulator of a buck-boost converter includes a first, a second, a third, and a fourth switches. A control circuit for controlling the switching regulator includes an error detector, a ramp signal generator, a comparator, an oscillator, and a control signal generator. The error detector generates an error signal corresponding to an output voltage of the switching regulator. The ramp signal generator generates a ramp signal. The comparator compares the error signal and the ramp signal to generate a comparison signal. The oscillator generates an oscillating signal. The control signal generator controls the first, the second, the third, and the fourth switches according to the comparison signal, the oscillating signal, and a clock signal, so that the switching regulator is configured to switch only between a boost mode and a buck mode, and not to operate at a buck-boost mode.

### CROSS-REFERENCE TO RELATED APPLICATIONS

This application claims the benefit of priority to Patent Application No. 101116279, filed in Taiwan on May 7, 2012; the entirety of which is incorporated herein by reference for all purposes.

### BACKGROUND

The disclosure generally relates to a buck-boost converter and, more particularly, to a control circuit for reducing switching loss of the buck-boost converter and related switching regulator.

In a traditional buck-boost converter, a switching regulator is configured to operate among a boost mode, a buck mode, and a buck-boost mode in turn so as to convert an input voltage into a required output voltage.

A conventional switching regulator comprises four power switches. When the switching regulator operates at the boost mode, only two of the four power switches are turned on alternatively. When the switching regulator operates at the buck mode, the other two power switches are turned on alternatively.

When the input voltage approximates to the output voltage, the conventional switching regulator operates at the buck-boost mode. In the buck-boost mode, the four power switches are turned on and turned off alternatively, thereby increasing the switching loss and reducing the energy conversion efficiency of the buck-boost converter.

### SUMMARY

In view of the foregoing, it can be appreciated that a substantial need exists for apparatuses that can reduce a switch loss of a buck-boost converter configured with a switching regulator, thereby improving an energy conversion efficiency of the buck-boost converter.

An example embodiment of a control circuit configured to operably control a switching regulator of a buck-boost converter is disclosed. The switching regulator comprises a first switch, a second switch, a third switch, and a fourth switch. The control circuit comprises: an error detector, configured to operably generate an error signal corresponding to an output voltage of the switching regulator; a ramp signal generator, configured to operably generate a ramp signal; a comparator, coupled with the error detector and the ramp signal generator, configured to operably compare the error signal and the ramp signal to generate a comparison signal; an oscillator, configured to operably generate an oscillating signal; and a control signal generator, coupled with the comparator and the oscillator, configured to operably control operations of the first, the second, the third, and the fourth switches according to the comparison signal, the oscillating signal, and a clock signal, so that the switching regulator is configured to switch only between a boost mode and a buck mode, and not to operate at a buck-boost mode.

One of the advantages of the above mentioned control circuit is that the switching regulator may be prevented from operating at the buck-boost mode so that at most two switches of the switching regulator switch simultaneously, thereby effectively reducing the switch loss of the buck-boost converter to improve the energy conversion efficiency of the buck-boost converter.

An example embodiment of a switching regulator for a buck-boost converter is disclosed, comprising: a first switch, comprising a first terminal for coupling with an input voltage and a second terminal for coupling with an external inductor; a second switch, comprising a first terminal coupled with the second terminal of the first switch; a third switch, comprising a first terminal for coupling with the external inductor; a fourth switch, comprising a first terminal coupled with the first terminal of the third switch and a second terminal configured to operably provide an output voltage; an error detector, configured to operably generate an error signal corresponding to the output voltage; a ramp signal generator, configured to operably generate a ramp signal; a comparator, coupled with the error detector and the ramp signal generator, configured to operably compare the error signal and the ramp signal to generate a comparison signal; an oscillator, configured to operably generate an oscillating signal; and a control signal generator, coupled with the comparator and the oscillator, configured to operably control operations of the first, the second, the third, and the fourth switches according to the comparison signal, the oscillating signal, and a clock signal, so that the switching regulator is configured to switch only between a boost mode and a buck mode, and not to operate at a buck-boost mode.

One of the advantages of the above mentioned switching regulator is that the switching regulator only operates at one of the boost mode and the buck mode, and would not operates at the buck-boost mode, thereby effectively reducing the switch loss to improve the energy conversion efficiency of the buck-boost converter.

### BRIEF DESCRIPTION OF THE DRAWINGS

FIG. 1 shows a simplified functional block diagram of a buck-boost converter according to one embodiment of the present disclosure.

FIG. 2 shows a simplified functional block diagram of a control circuit in FIG. 1 according to one embodiment of the present disclosure.

FIG. 3 shows a simplified timing diagram of the operation of the control circuit in FIG. 1 when an input voltage of the switching regulator is greater than an output voltage of the switching regulator according to one embodiment of the present disclosure.

FIG. 4 shows a simplified timing diagram of the operation of the control circuit in FIG. 1 when the input voltage of the switching regulator is greater than the output voltage of the switching regulator according to one embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to . . . ” Also, the phrase “coupled with” is intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a”, “an”, and “the” herein are intended to comprise the plural forms as well, unless the context clearly indicates otherwise.

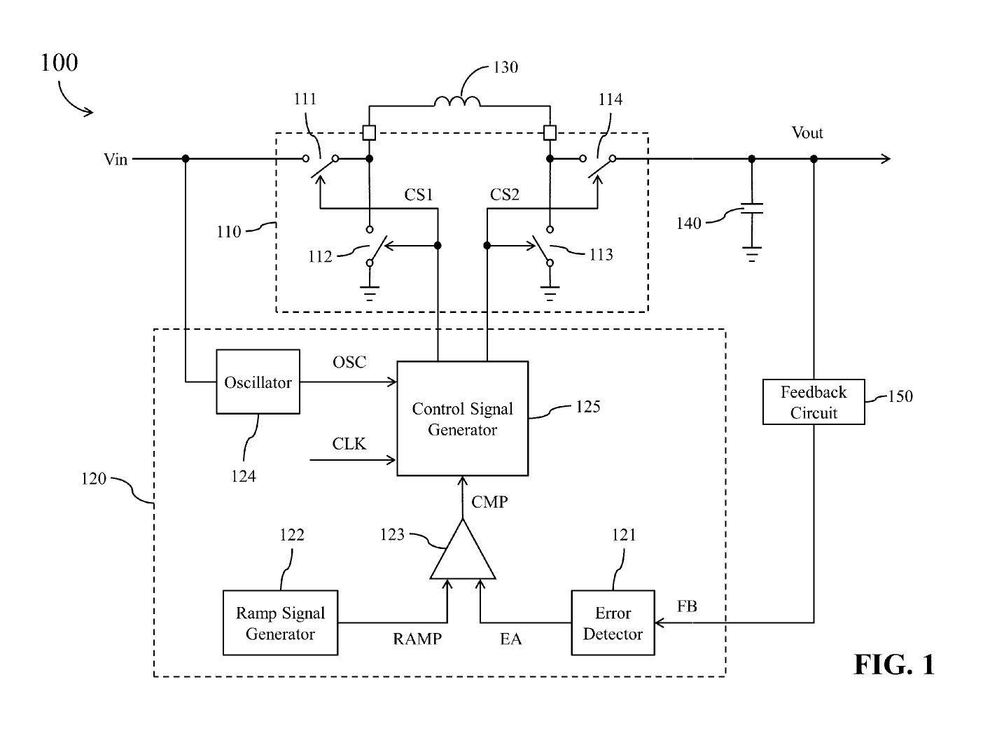

FIG. 1 shows a simplified functional block diagram of a buck-boost converter 100 according to one embodiment of the present disclosure. The buck-boost converter 100 comprises a switching regulator 110, a control circuit 120, an inductor 130, a capacitor 140, and a feedback circuit 150. The switching regulator 110 is utilized for coupling with an input voltage Vin and the inductor 130, and is configured to operably convert the input voltage Vin into an output voltage Vout for supplying to a subsequent circuit. The capacitor 140 is coupled with an output of the switching regulator 110 to reduce noises of the output voltage Vout. The feedback circuit 150 is coupled with the output voltage Vout to generate a feedback signal FB having a magnitude corresponding to the output voltage Vout. In practice, the feedback circuit 150 may be realized by simple divider resistors or other suitable circuit structure.

When the control circuit 120 is coupled with the switching regulator 110, the control circuit 120 may generate a first control signal CS1 and a second control signal CS2 according to the input voltage Vin and the feedback signal FB to control operations of the switching regulator 110.

As shown in FIG. 1, the switching regulator 110 comprises a first switch 111, a second switch 112, a third switch 113, and a fourth switch 114. A first terminal of the switch 111 is utilized for coupling with the input voltage Vin and a second terminal of the switch 111 is utilized for coupling with the inductor 130. A first terminal of the switch 112 is coupled with the second terminal of the switch 111 and a second terminal of the switch 112 is coupled with a fixed-voltage terminal (such as a grounded terminal). A first terminal of the switch 113 is utilized for coupling with the inductor 130 and a second terminal of the switch 113 is coupled with a fixed-voltage terminal (such as the grounded terminal). A first terminal of the switch 114 is coupled with the first terminal of the switch 113 and a second terminal of the switch 114 is configured to operably provide the output voltage Vout.

In this embodiment, the control circuit 120 comprises an error detector 121, a ramp signal generator 122, a comparator 123, an oscillator 124, and a control signal generator 125. The error detector 121 is configured to operably generate an error signal EA corresponding to the output voltage Vout of the switching regulator 110. For example, the error detector 121 may generate the error signal EA according to the feedback signal FB. The ramp signal generator 122 is configured to operably generate a ramp signal RAMP. Two input terminals of the comparator 123 are respectively coupled with the error detector 121 and the ramp signal generator 122. The comparator 123 is configured to operably compare the error signal EA and the ramp signal RAMP to generate a comparison signal CMP. The oscillator 124 is configured to operably generate an oscillating signal OSC according to the input voltage Vin of the switching regulator 110 so that a duty ratio of the oscillating signal OSC is directly proportional to a magnitude of the input voltage Vin. For example, when the input voltage Vin decreases, the oscillator 124 may decrease the duty ratio of the oscillating signal OSC correspondingly; and when the input voltage Vin increases, the oscillator 124 may increase the duty ratio of the oscillating signal OSC correspondingly. The control signal generator 125 is coupled with the comparator 123, the oscillator 124, and a clock signal CLK. The control signal generator 125 is configured to operably generate the control signals CS1 and CS2 according to the comparison signal CMP, the oscillating signal OSC, and the clock signal CLK to control operations of the switches 111˜114 in order to configure the switching regulator 110 to operate only at a boost mode or a buck mode, and not to operate at a buck-boost mode.

In the descriptions, the term “boost mode” refers to an operation of the switching regulator 110 where the switching regulator operates in a time period at which the switch 113 and the switch 114 are turned on and turned off alternatively, the switch 111 is maintained in the turned on status, and the switch 112 is maintained in the turned off status. The term “buck mode” refers to an operation of the switching regulator 110 where the switching regulator 110 operates in a time period at which the switch 111 and the switch 112 are turned on and turned off alternatively, the switch 113 is maintained in the turned off status, and the switch 114 is maintained in the turned on status. The term “buck-boost mode” refers to an operation of the switching regulator 110 where the switching regulator 110 operates in a time period at which the switches 111˜114 are turned on and turned off alternatively.

An appropriate driving circuit may be arranged between the control signal generator 125 and the switching regulator 110 according to the requirement of circuit design.

In practice, the inductor 130 may be arranged outside the switching regulator 110, or may be integrated into the switching regulator 110. In addition, the control circuit 120 and the switching regulator 110 may be respectively arranged in different circuit chips. Alternatively, the control circuit 120 may be integrated into the switching regulator 110 to form a single circuit chip.

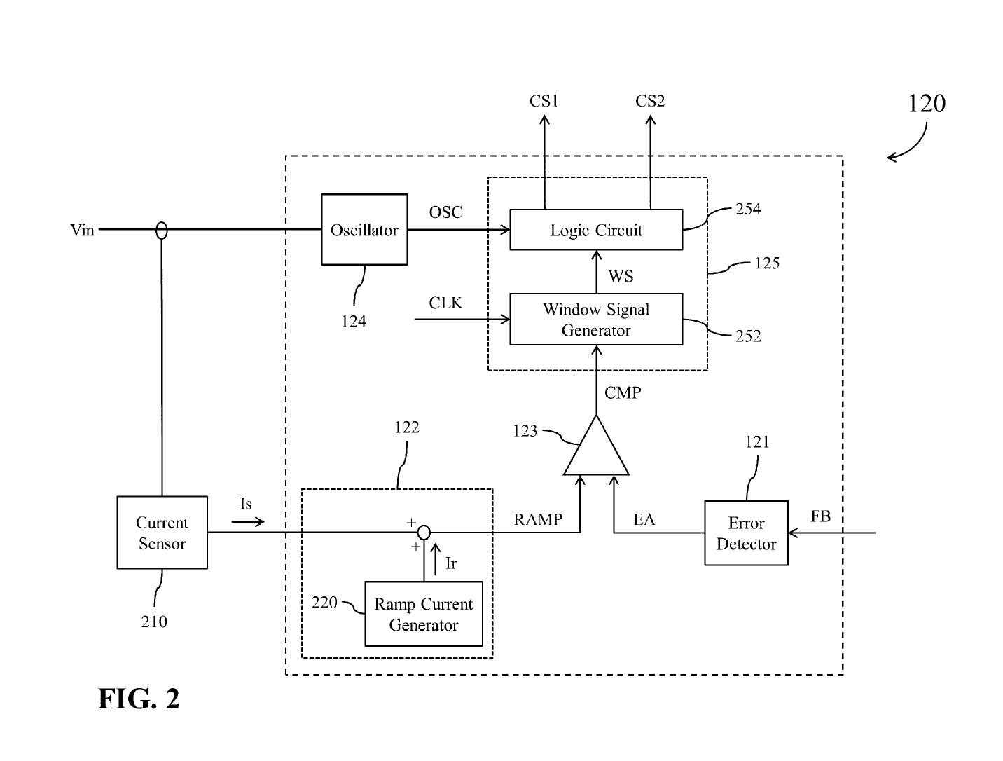

Operations of the control circuit 120 will be further described in the following by reference to FIGS. 2˜4.

FIG. 2 shows a simplified functional block diagram of the control circuit 120 in FIG. 1 according to one embodiment of the present disclosure. In general, a current sensor 210 is typically arranged in the buck-boost converter 100 to generate a sensing signal Is having a magnitude corresponding to the input voltage Vin. Thus, in the embodiment shown in FIG. 2, the ramp signal generator 122 of the control circuit 120 may utilize a ramp current generator 220 to generate a ramp current Ir, and to superimpose the ramp current Ir with the sensing signal Is to form the ramp signal RAMP.

In the embodiment shown in FIG. 2, the control signal generator 125 comprises a window signal generator 252 and a logic circuit 254. The window signal generator 252 is coupled with an output of the comparator 123 and the clock signal CLK, and is configured to operably generate a window signal WS according to the comparison signal CMP and the clock signal CLK. The logic circuit 254 is coupled with the oscillator 124 and the window signal generator 252, and is configured to operably generate the control signals CS1 and CS2 according to the oscillating signal OSC and the window signal WS to control the operations of the switches 111˜114.

In this embodiment, the control signal CS1 is utilized for controlling the operations of the switch 111 and the switch 112, and the control signal CS2 is utilized for controlling the operations of the switch 113 and the switch 114, wherein the switch 111 and the switch 112 are turned on at opposite logic levels of the control signal CS1, and the switch 113 and the switch 114 are turned on at opposite logic levels of the control signal CS2.

When the input voltage Vin of the switching regulator 110 is greater than a required output voltage Vout, the control circuit 120 configures the switching regulator 110 to operate mainly at the buck mode. When the input voltage Vin of the switching regulator 110 is less than the required output voltage Vout, the control circuit 120 configures the switching regulator 110 to operate mainly at the boost mode.

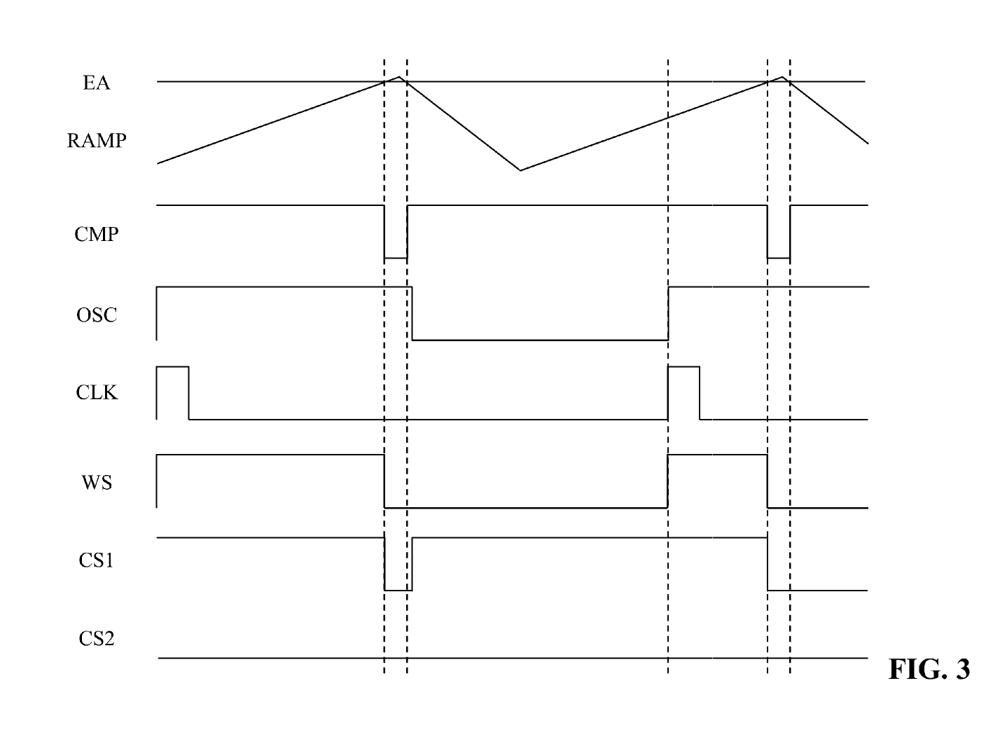

FIG. 3 shows a simplified timing diagram of the operation of the control circuit 120 when the input voltage Vin of the switching regulator 110 is greater than the output voltage Vout of the switching regulator 110 according to one embodiment of the present disclosure. As shown in FIG. 3, the comparator 123 compares the error signal EA with the ramp signal RAMP to generate the comparison signal CMP.

The window signal generator 252 of the control signal generator 125 switches the logic level of the window signal WS when triggered by a first type edge of the clock signal CLK, and then switches the logic level of the window signal WS when triggered by a second type edge of the comparison signal CMP. For example, in the embodiment of FIG. 3, the window signal generator 252 switches the window signal WS to a logic high level when triggered by the rising edge of the clock signal CLK, and switches the window signal WS to a logic low level when triggered by the falling edge of the comparison signal CMP.

When the input voltage Vin of the switching regulator 110 is greater than the required output voltage Vout, the logic circuit 254 of the control signal generator 125 utilizes the control signal CS1 to alternatively turn on the switch 111 and the switch 112, and maintains the control signal CS2 at a fixed voltage level (e.g., the low voltage level shown in FIG. 3) to maintain the switch 113 in the turn off status and maintain the switch 114 in the turn on status.

For example, in the embodiment of FIG. 3, when the oscillating signal OSC and the window signal WS are at the same logic level, the logic circuit 254 configures the control signal CS1 to a first voltage level (e.g., the high voltage level shown in FIG. 3) to turn on the switch 111 and simultaneously turn off the switch 112. When the oscillating signal OSC and the window signal WS are at different logic levels, the logic circuit 254 switches the control signal CS1 to a second voltage level (e.g., the low voltage level shown in FIG. 3) to turn on the switch 112 and simultaneously turn off the switch 111. As the change in the logic levels of the oscillating signal OSC and the window signal WS, the control signal CS1 generated by the logic circuit 254 is alternatively switched between the high voltage level and the low voltage level, thereby alternatively turning on the switch 111 and the switch 112.

During the above operations, the switching regulator 110 mainly operates at the buck mode except for a tiny switching latency caused by the non-ideality of circuit components (such as the switches 111˜114).

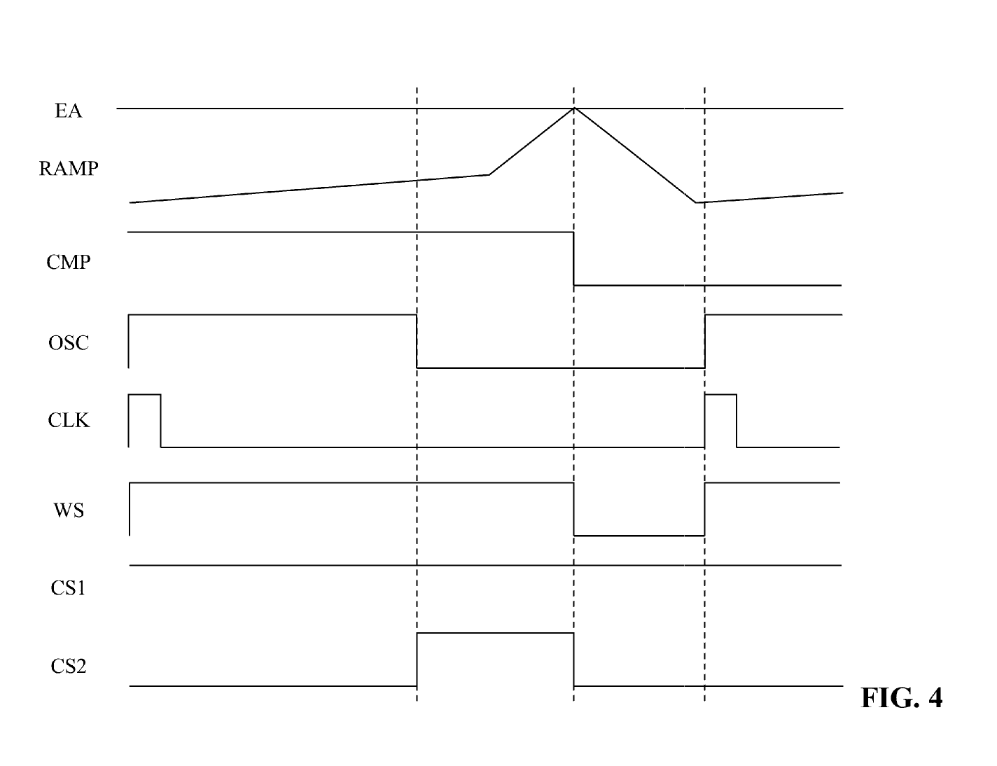

FIG. 4 shows a simplified timing diagram of the operation of the control circuit 120 when the input voltage Vin of the switching regulator 110 is greater than the output voltage Vout of the switching regulator 110 according to one embodiment of the present disclosure.

The window signal generator 252 of the control signal generator 125 also switches the logic level of the window signal WS when triggered by the first type edge of the clock signal CLK, and then switches the logic level of the window signal WS when triggered by the second type edge of the comparison signal CMP. For example, in the embodiment of FIG. 4, the window signal generator 252 switches the window signal WS to the logic high level when triggered by the rising edge of the clock signal CLK, and switches the window signal WS to the logic low level when triggered by the falling edge of the comparison signal CMP.

When the input voltage Vin of the switching regulator 110 is less than the required output voltage Vout, the logic circuit 254 of the control signal generator 125 utilizes the control signal CS2 to alternatively turn on the switch 113 and the switch 114, and maintains the control signal CS1 at a fixed voltage level (e.g., the high voltage level shown in FIG. 4) to maintain the switch 111 in the turn off status and maintain the switch 112 in the turn on status.

For example, in the embodiment of FIG. 4, when the oscillating signal OSC and the window signal WS are at different logic levels, the logic circuit 254 configures the control signal CS3 to a third voltage level (e.g., the high voltage level shown in FIG. 4) to turn on the switch 113 and simultaneously turn off the switch 114. When the oscillating signal OSC and the window signal WS are at the same logic level, the logic circuit 254 switches the control signal CS2 to a fourth voltage level (e.g., the low voltage level shown in FIG. 4) to turn on the switch 114 and simultaneously turn off the switch 113. As the change in the logic levels of the oscillating signal OSC and the window signal WS, the control signal CS2 generated by the logic circuit 254 is alternatively switched between the high voltage level and the low voltage level, thereby alternatively turning on the switch 113 and the switch 114.

It can be appreciated from the foregoing descriptions that when the input voltage Vin of the switching regulator 110 is greater than the required output voltage Vout, the control circuit 120 maintains the switch 113 in the turn off status and simultaneously maintains the switch 114 in the turn on status, instead of alternatively switching the switches 113 and 114. On the contrary, when the input voltage Vin of the switching regulator 110 is less than the required output voltage Vout, the control circuit 120 maintains the switch 111 in the turn on status and simultaneously maintains the switch 112 in the turn off status, instead of alternatively switching the switches 111 and 112.

During the above operations, the switching regulator 110 mainly operates at the boost mode except for a tiny switching latency caused by the non-ideality of circuit components (such as the switches 111˜114).

In the control circuit 120, only a single comparator 123 is employed to compare the error signal EA with the ramp signal RAMP to generate the comparison signal CMP required by the control signal generator 125. Accordingly, when the input voltage Vin of the switching regulator 110 approximates to the required output voltage Vout, the control signal generator 125 only performs either the operation illustrated in FIG. 3 or the operation illustrated in FIG. 4 to configure the switching regulator 110 to operate at either the buck mode or the boost mode. That is, when the input voltage Vin of the switching regulator 110 is greater than the required output voltage Vout, the control circuit 120 configures the switching regulator 110 to operate mainly at the buck mode even if the input voltage Vin is very close to the output voltage Vout. On the contrary, when the input voltage Vin of the switching regulator 110 is less than the required output voltage Vout, the control circuit 120 configures the switching regulator 110 to operate mainly at the boost mode even if the input voltage Vin is very close to the output voltage Vout. Therefore, under the control of the control circuit 120, the operations of the switching regulator 110 would be switched only between the boost mode and the buck mode, and would not be switched to the buck-boost mode. As a result, the switching loss of the buck-boost converter 100 can be effectively reduced, thereby improving the energy conversion efficiency of the buck-boost converter 100.

Under the control of the control circuit 120, the slope of the inductor current in the switching regulator 110 in the period at which the input voltage Vin approximates to the output voltage Vout would be much smoother than the slope in the traditional buck-boost converter. This structure further reduces the conduction loss of the switching regulator 110 to further improve the energy conversion efficiency of the buck-boost converter 100.

In addition, since the control circuit 120 utilizes only a single comparator 123 to compare the error signal EA and the ramp signal RAMP, the required circuitry area can be further reduced.

In previous embodiments, the ramp signal RAMP generated by the ramp signal generator 122 is realized in the format of a current signal, but this is merely an embodiment rather than a restriction to the practical implementations of the ramp signal generator 122. For example, the ramp signal generator 122 may be designed to generate a ramp signal in the format of a voltage signal. In practice, the ramp signal generator 122 may generate the ramp signal according to the input voltage Vin of the switching regulator 110, or may instead generate the ramp signal according to the output voltage Vout of the switching regulator 110. In some embodiments, the ramp signal generator 122 may independently generate the ramp signal without referencing to the input voltage Vin and the output voltage Vout.

Additionally, in the previous embodiments, the control signals of some switches of the switching regulator 110 are active high, and the control signals of the other some switches are active low, but this is merely an embodiment rather than a restriction to the practical implementations of the control signals of these switches.

In the aforementioned control circuit 120, the oscillator 124 changes the duty ratio of the oscillating signal OSC as the input voltage Vin, so that the duty ratio of the oscillating signal OSC is directly proportional to the magnitude of the input voltage Vin. This structure enables the control circuit 120 to increase the response speed with respect to the input voltage Vin, but this is merely an embodiment rather than a restriction to the practical implementations of the oscillator 124. For example, in some embodiments, the oscillator 124 may be designed to generate an oscillating signal having a fixed duty ratio in order to reduce the circuitry complexity.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A control circuit for controlling a switching regulator of a buck-boost converter, wherein the switching regulator comprises a first switch, a second switch, a third switch, and a fourth switch, the control circuit comprising:
an error detector, configured to operably generate an error signal corresponding to an output voltage of the switching regulator;
a ramp signal generator, configured to operably generate a ramp signal;
a comparator, coupled with the error detector and the ramp signal generator, configured to operably compare the error signal and the ramp signal to generate a comparison signal;
an oscillator, configured to operably generate an oscillating signal; and
a control signal generator, coupled with the comparator and the oscillator, configured to operably control operations of the first, the second, the third, and the fourth switches according to the comparison signal, the oscillating signal, and a clock signal, so that the switching regulator is configured to switch only between a boost mode and a buck mode, and not to operate at a buck-boost mode.

2. The control circuit of claim 1, wherein the control signal generator comprises:
a window signal generator, coupled with the comparator, configured to operably generate a window signal according to the comparison signal and the clock signal; and
a logic circuit, coupled with the oscillator and the window signal generator, configured to operably generate multiple control signals according to the oscillating signal and the window signal to control operations of the first, the second, the third, and the fourth switches.

3. The control circuit of claim 2, wherein the window signal generator switches a logic level of the window signal when triggered by a first type edge of the clock signal, and switches the logic level of the window signal when triggered by a second type edge of the comparison signal.

4. The control circuit of claim 3, wherein the window signal generator switches the window signal to a first logic level when triggered by a rising edge of the clock signal, and switches the window signal to a second logic level when triggered by a falling edge of the comparison signal.

5. The control circuit of claim 2, wherein if the control signal generator configures the switching regulator to operate at the buck mode, the logic circuit configures a first control signal utilized for controlling the first switch and the second switch to a first voltage level when the oscillating signal and the window signal are at a same logic level, and the logic circuit configures the first control signal to a second voltage level when the oscillating signal and the window signal are at different logic levels.

6. The control circuit of claim 5, wherein if the control signal generator configures the switching regulator to operate at the boost mode, the logic circuit configures a second control signal utilized for controlling the third switch and the fourth switch to a third voltage level when the oscillating signal and the window signal are at different logic levels, and the logic circuit configures the second control signal to a fourth voltage level when the oscillating signal and the window signal are at a same logic level.

7. The control circuit of claim 2, wherein the ramp signal generator comprises:
a ramp current generator, configured to operably generate a ramp current;
wherein the ramp current is superimposed with a sensing signal having a magnitude corresponding to an input voltage to form the ramp signal.

8. The control circuit of claim 1, wherein the ramp signal generator comprises:
a ramp current generator, configured to operably generate a ramp current;
wherein the ramp current is superimposed with a sensing signal having a magnitude corresponding to an input voltage to form the ramp signal.

9. The control circuit of claim 1, wherein the oscillator generates the oscillating signal according to an input voltage so that a duty ratio of the oscillating signal is directly proportional to a magnitude of the input voltage.

10. A switching regulator for a buck-boost converter, comprising:
a first switch, comprising a first terminal for coupling with an input voltage and a second terminal for coupling with an external inductor;
a second switch, comprising a first terminal coupled with the second terminal of the first switch;
a third switch, comprising a first terminal for coupling with the external inductor;
a fourth switch, comprising a first terminal coupled with the first terminal of the third switch and a second terminal configured to operably provide an output voltage;
an error detector, configured to operably generate an error signal corresponding to the output voltage;
a ramp signal generator, configured to operably generate a ramp signal;
a comparator, coupled with the error detector and the ramp signal generator, configured to operably compare the error signal and the ramp signal to generate a comparison signal;
an oscillator, configured to operably generate an oscillating signal; and
a control signal generator, coupled with the comparator and the oscillator, configured to operably control operations of the first, the second, the third, and the fourth switches according to the comparison signal, the oscillating signal, and a clock signal, so that the switching regulator is configured to switch only between a boost mode and a buck mode, and not to operate at a buck-boost mode.

11. The switching regulator of claim 10, wherein the control signal generator comprising:
a window signal generator, coupled with the comparator, configured to operably generate a window signal according to the comparison signal and the clock signal; and
a logic circuit, coupled with the oscillator and the window signal generator, configured to operably generate multiple control signals according to the oscillating signal and the window signal to control the operations of the first, the second, the third, and the fourth switches.

12. The switching regulator of claim 11, wherein the window signal generator switches a logic level of the window signal when triggered by a first type edge of the clock signal, and switches the logic level of the window signal when triggered by a second type edge of the comparison signal.

13. The switching regulator of claim 12, wherein the window signal generator switches the window signal to a first logic level when triggered by a rising edge of the clock signal, and switches the window signal to a second logic level when triggered by a falling edge of the comparison signal.

14. The switching regulator of claim 11, wherein if the control signal generator configures the switching regulator to operate at the buck mode, the logic circuit configures a first control signal utilized for controlling the first switch and the second switch to a first voltage level when the oscillating signal and the window signal are at a same logic level, and the logic circuit configures the first control signal to a second voltage level when the oscillating signal and the window signal are at different logic levels.

15. The switching regulator of claim 14, wherein if the control signal generator configures the switching regulator to operate at the boost mode, the logic circuit configures a second control signal utilized for controlling the third switch and the fourth switch to a third voltage level when the oscillating signal and the window signal are at different logic levels, and the logic circuit configures the second control signal to a fourth voltage level when the oscillating signal and the window signal are at a same logic level.

16. The switching regulator of claim 11, wherein the ramp signal generator comprises:
a ramp current generator, configured to operably generate a ramp current;
wherein the ramp current is superimposed with a sensing signal having a magnitude corresponding to the input voltage to form the ramp signal.

17. The switching regulator of claim 10, wherein the ramp signal generator comprises:
a ramp current generator, configured to operably generate a ramp current;
wherein the ramp current is superimposed with a sensing signal having a magnitude corresponding to the input voltage to form the ramp signal.

18. The switching regulator of claim 10, wherein the oscillator generates the oscillating signal according to the input voltage so that a duty ratio of the oscillating signal is directly proportional to a magnitude of the input voltage.
